(19) United States
(12) Patent Application Publication
(10) Pub. No.: US 2013/0258637 A1
(43) Pub. Date: Oct. 3, 2013

(54) WAVELENGTH-CONVERTING STRUCTURE FOR A LIGHT SOURCE

(71) Applicants: Michael Dongxue Wang, Santa Clara, CA (US); Alan Lenef, Belmont, MA (US)

(72) Inventors: Michael Dongxue Wang, Santa Clara, CA (US); Alan Lenef, Belmont, MA (US)

(21) Appl. No.: 13/436,846

(22) Filed: Mar. 31, 2012

(51) Int. Cl. F21V 9/16

(52) U.S. Cl. 362/84

(57) ABSTRACT

A wavelength-converting structure for a light module including a solid-state light source. The wavelength-converting structure includes a plurality of apertures formed therein. The plurality of apertures may be configured to increase conversion efficiency of the wavelength-converting structure or color uniformity.

### CROSS-REFERENCE TO RELATED APPLICATIONS

This application is related to co-pending application Attorney Docket No. 2012P24783US filed concurrently herewith.

### FIELD

The present disclosure relates generally to solid-state light sources, and, more particularly, to a light emitting diode (LED) light source including a wavelength-converting structure.

### BACKGROUND

Solid-state lighting may include one or more LEDs, and/or laser diodes, as a source of illumination and provide numerous benefits including, but not limited to, increased efficiency and lifespan. Known LED chips generate visible or non-visible light in a specific region of the light spectrum. The light output from the LED may be, for example, blue, red, green or non-visible ultra-violet (UV) or near-UV, depending on the material composition of the LED. When it is desired to construct an LED light source that produces a color different from the output color of the LED, it is known to convert the LED light output having a peak wavelength (the “primary light” or “excitation light”) to light having a different peak wavelength (the “secondary light” or “emission light”) using photoluminescence.

The photoluminescence process involves absorbing the higher energy primary light by a wavelength-converting material such as a phosphor or mixture of phosphors thereby exciting the phosphor material, which emits the secondary light. The peak wavelength of the secondary light depends on the type of phosphor material, which can be chosen to provide secondary light having a particular peak wavelength. This process may be generally referred to as “wavelength down conversion” and an LED combined with a wavelength-converting structure that includes wavelength-converting material, such as phosphor, to produce secondary light, may be described as a “phosphor-converted LED” or “wavelength-converted LED.”

In a known configuration, an LED die, such as a III-nitride die, is positioned in a reflector cup package and a volume, conformal layer or thin film including a wavelength-converting material is deposited directly on the surface of the die. In another known configuration, the wavelength-converting material may be provided in a solid, self-supporting flat structure, such as a ceramic plate, single crystal plate or thin film structure. Such a plate may be referred to herein as a “wavelength-converting plate.” The plate may be attached directly to the LED, e.g. by wafer bonding, sintering, gluing, etc. Alternatively, the plate may be positioned remotely from the LED by an intermediate element.

One drawback associated with using wavelength-converting plate configurations is that the path length of the primary light inside the plate increases with changes in viewing angle from 0 degrees to the normal (typically defined at 90 degrees to the top surface of the wavelength-converting plate) to higher angles. These effects may contribute to different color light being emitted at angles close to the normal compared to the higher angles and is known as color angular spread or color separation (ΔCx, ΔCy). For example, in the case of a wavelength-converting plate comprised of cerium-activated yttrium aluminum garnet (YAG:Ce) combined with a blue InGaN LED chip, bluer light may be emitted at angles near normal to the chip while yellower light may be emitted at angles far from the normal. In this case, incident primary light (e.g. blue light) may interact over differing optical path lengths as a function of incident angles, ultimately making it difficult to achieve color uniformity. In addition, depending on the processing method and/or properties of the wavelength-converting material of such plates, at least a portion of the primary light and/or secondary light may be lost due to internal reflection, scattering, and/or absorption in the wavelength-converting plate.

Some configurations have attempted to address such color mixing issues by providing methods of combining the LED radiation pattern for the primary light with emission of the converted light from phosphors. For example, in some configurations, a scattering medium (e.g. pores or phosphor particles) may be used to redistribute the primary light radiation pattern to better match the secondary light. However, such configurations are dependent upon the specific properties of the wavelength-converting structure and primary light source. In the case of full conversion of primary light, whereby all or most of the primary light is converted, some configurations include specific optics and/or diffusers to combine the spatially disparate sources of color, which may be difficult, expensive, and ineffective.

Another drawback associated with some wavelength-converting plate configurations is related to multiple internal interfaces of phosphor that may impede heat transfer and therefore dissipation of heat produced by the LED and phosphor materials. In particular, heat generated by Stokes shift in the phosphor material may be difficult to dissipate, and may cause the temperature of the plate structure to rise, thereby reducing conversion efficiency of the phosphor material of such plates. Excess generated heat may further reduce lifespan and/or lumen output of the LED. Some configurations have attempted to address such thermal issues by including heat dissipating structures, such as heat sinks, and/or driving the LEDs with low current.

### BRIEF DESCRIPTION OF THE DRAWINGS

Reference should be made to the following detailed description which should be read in conjunction with the following figures, wherein like numerals represent like parts:

FIG. 1 diagrammatically illustrates in cross section one embodiment of a wavelength-converted LED assembly including a wavelength-converting plate consistent with the present disclosure;

FIG. 2 diagrammatically illustrates in cross section another embodiment of a wavelength-converted LED assembly consistent with the present disclosure;

FIG. 3 diagrammatically illustrates the wavelength-converting plate shown in FIG. 1 in perspective view;

FIG. 4 diagrammatically illustrates another embodiment of a wavelength-converting plate consistent with the present disclosure in perspective view; and

FIGS. 5A-5B diagrammatically illustrate in cross section other embodiments of a wavelength-converting plate consistent with the present disclosure.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient. Also, it should be understood that the phraseology and terminology used herein is for the purpose of description and should not be regarded as limiting.

References to the color of a phosphor, LED or conversion material refer generally to its emission color unless otherwise specified. Thus, a blue LED emits a blue light, a yellow phosphor emits a yellow light and so on.

### DETAILED DESCRIPTION

By way of a brief overview, one embodiment of the present disclosure may feature a wavelength-converting plate that includes a plurality of apertures defined therein. The wavelength-converting plate may be combined into a light module such as a wavelength-converted LED assembly whereby primary light emitted by an LED passes through a bottom surface of the plate. The wavelength-converting plate is configured to emit a secondary light in response to the primary light imparted thereon. The primary light may be converted to secondary light by the wavelength-converting material of the plate. At least one of the apertures may be configured to allow a portion of primary light emitted by the LED to pass through the plate. The secondary light and primary light may then pass from the wavelength-converting plate through additional optics, such as a diffuser, configured to mix the secondary and primary lights to provide light output having improved color uniformity.

A wavelength-converting plate consistent with at least one embodiment of the present disclosure may provide numerous advantages. For example, the plurality of apertures defined in the wavelength-converting plate may increase the interaction area between the LED light and the wavelength-converting material of the plate. This, in turn, may allow more primary light from the LED to scatter within the plate, resulting in an increase in path lengths and interaction between the primary light and wavelength-converting material, thereby improving conversion efficiency of the primary light to secondary light. In addition, an increase in interaction area may also allow a low concentration of activator ions (luminescent ions) in the wavelength-converting material, resulting in a reduction of ion-ion interactions, thereby increasing conversion efficiency. The plurality of apertures may also provide convective pathways for dissipating thermal energy generated by the LED and/or wavelength-converting material of the plate. Finally, scattering and reflection of the primary light within the apertures increase the amount of primary light emitted from the converting plate at higher angles, thereby improving the primary light component in the radiation pattern.

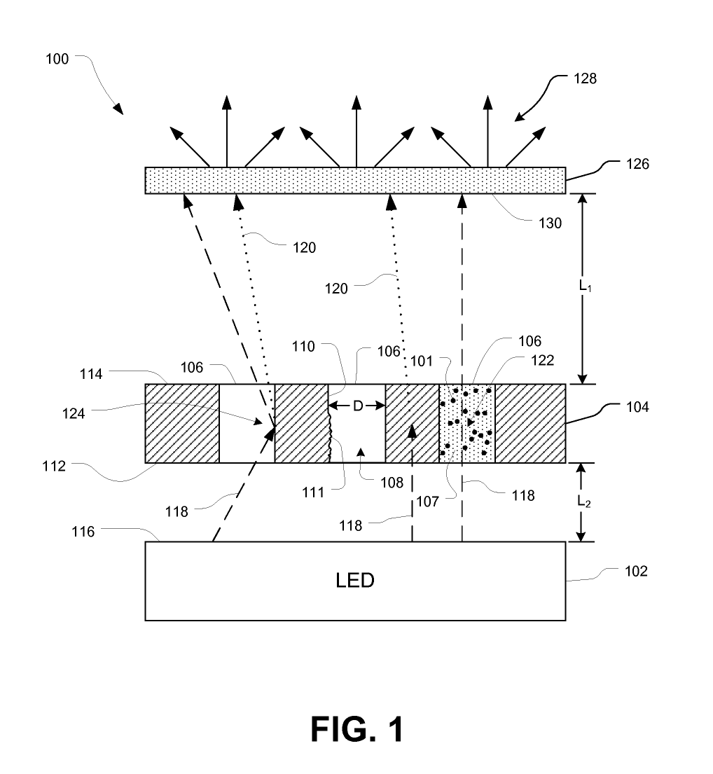

Turning now to the figures, FIG. 1 generally illustrates in cross section one embodiment of a light module configured as a wavelength-converted LED assembly 100 consistent with the present disclosure. The illustrated assembly 100 includes a known LED 102 and a wavelength-converting plate 104 (hereinafter referred to as “plate 104” for ease of description) having a plurality of apertures 106 defined therein. At least one of the plurality of apertures 106 may form a through hole 108 having a sidewall 110. The through hole 108 extends entirely through the plate 104 from the bottom surface 112 of the plate 104 to the top surface 114 of the plate 104. At least a portion 111 of the sidewall 110 may be textured or roughed as compared to a smooth or polished surface.

The plate 104 may take any known wavelength-converting plate configuration and may be a flat plate, such as a ceramic plate, single crystal plate or thin film structure having a wavelength-converting material or mixture of wavelength-converting materials therein. The plate 104 may be constructed using materials and combinations of materials including known phosphors for achieving a desired wavelength conversion, including, but not limited to, yellow phosphor, green phosphor, red phosphor, and/or combinations thereof. In one embodiment, the plate 104 may include multiple types of phosphors (yellow, green, red) arranged in a desired distribution and/or pattern within the plate 104. The use of a combination of phosphor types may provide improved color rendering. The particular distribution and/or pattern, as well as size, of the phosphor types can be controlled to achieve desired near-field light distributions, optimal thermal characteristics, as well as improved angular performance.

As generally understood by one skilled in the art, phosphors are compounds capable of emitting useful quantities of radiation in the visible and/or ultraviolet spectrum upon excitation of the phosphor compound by an external energy source. Inorganic phosphor compounds may include a host material doped with a small amount of an activator ion. The phosphor may be in the form of phosphor powders dispersed in optical quality silicone or formed as a sintered ceramic. Known phosphors include, but are not limited to, cerium-activated yttrium aluminum garnet (YAG:Ce), cerium-activated lutetium aluminum garnet (LuAG:Ce), europium-activated strontium silicon oxynitride (Sr—SiON:Eu), etc.

The plurality of apertures 106 may be formed in the plate 104 during or after the forming of the plate 104. In one embodiment, the plate 104 may include phosphor dispersed in optical quality silicone. The plate 104 may be made by a known molding or template method in which phosphor silicone mixes may be injected into a desired mold or template cell to make a plate including a plurality of apertures formed therein. Alternatively, a plate may be made by a known molding or template method without a plurality of apertures formed therein during the formation process, wherein the plurality of apertures may be later formed on the plate by any known drilling or stamping process, as well as, any known photo-lithograph techniques. It should be noted that a plate 104 consistent with the present disclosure is not limited to silicone as a host material matrix for the phosphor materials. For example, a plate 104 consistent with the present disclosure may include a ceramic material and may be fabricated by known ceramic processing techniques that may include forming in the green state, injection molding, thermally processed into a final sintered state.

The LED 102 may be any known LED serving as a light source, including, but not limited to a nitride III-V LED such as an InGaN LED. It is to be understood that the assembly 102 may include a single LED 102 or an array of LEDs. Alternatively, or in addition, the assembly 100 may include a laser diode serving as a light source. In another embodiment, the LED and/or laser diode may be coupled with a light guide to form a surface emitter. Preferably, the LED 102 is a blue LED or laser diode that emits in a wavelength range from 420 nm to 490 nm, or even more preferably 450 nm to 475 nm.

The LED 102 emits primary light at a peak wavelength through an emitting surface 116 thereof. The bottom surface 112 of the plate 104 is positioned in opposed facing relationship to the emitting surface 116 of the LED 102. It is to be understood that FIG. 1 is provided in diagrammatic form for ease of illustration and explanation, and, for example, the bottom surface 112 of the wavelength converting plate 104 and the emitting surface 116 the LED 102 may have substantially different (roughened, structured, etc.) character from the indicated flat/polished surfaces, depending on the desired optical out-coupling and in-coupling.

Generally, primary light, e.g. indicated by arrows 118, emitted from the emitting surface 116 of the LED 102 is imparted onto the bottom surface 112 of the plate 104. Some of the primary light 118 may pass into and through the bottom surface 112 of the plate 104, wherein some of the primary light 118 may interact with and excite the wavelength-converting material within the plate 104, wherein the plate 104 may emit secondary light 120. Some of the primary light 118 passing into the bottom surface 112 of the plate 104 may pass through the plate 104 from the bottom surface 112 to the top surface 114 without interacting with the wavelength-converting material and thus remain unconverted.

At least one of the plurality of apertures 106 may be configured to allow some of the primary light 118 imparted upon the plate 104 to pass at least partially through the plate 104 without being imparted on a surface thereof. In particular, some primary light 118 may pass directly through a through hole 108 of at least one aperture 106, as indicated by arrow 122, thereby passing entirely through the plate 104, i.e. from the bottom surface 112 of the plate 104 to the top surface 114 of the plate 104, without being imparted on any surface of the plate 104. Depending on the angular orientation of the LED 102, some primary light 118 may be imparted upon and reflected by the sidewall 110 of the through hole 108 of at least one aperture 106, as indicated by arrow 124.

The plurality of apertures 106 may be configured to increase the interaction area between the primary light 118 emitted by the LED 102 and the wavelength-converting material of the plate 104. In turn, an increase in interaction area may allow more primary light 118 from the LED 102 to scatter within the plate 104 and increase interaction path lengths between the primary light and the wavelength-converting material, thereby improving conversion efficiency. In addition, an increase in interaction area may also allow a low concentration of activator ions (luminescent ions) in the wavelength-converting material, resulting in a reduction of ion-ion interactions, thereby increasing conversion efficiency. In addition, the apertures 106 may be configured to adapt to a varying LED angular distribution of primary light 118 emitted by the LED 102.

Additionally, the plurality of apertures 106 may also provide convective pathways for dissipating thermal energy generated by the LED 102 and/or wavelength-converting material of the plate 104. In one embodiment, the plurality of apertures 106 may be filled with an optically transparent and thermally conductive material 107 having a refractive index close to or the same as the wavelength-converting material. The material 107 may be configured to improve conduction of thermal energy associated with, for example, Stoke shifts during down conversions in the wavelength-converting material. The material 107 may include, for example, acrylic, PMMA, and/or other optically transparent materials, such as microfluidic or nanofluidic materials. The plurality of apertures 106 may be configured to operate with a lighting fixture to facilitate convective cooling. The plurality of apertures 106 may also be filled with light scattering particles 101 configured to perform color mixing and illumination pattern engineering.

The secondary light 120 and some of the primary light 118 may pass through the top surface 114 of the plate 104 and may also pass through a diffuser 126. The diffuser 126 may be configured to mix the primary 118 and secondary light 120 from the plate 104 and provide output light 128 having improved color uniformity. The output light 128 may be a white and/or narrow-band light, depending on the phosphor composition of plate 104. It is to be understood that the output light 128 may be polarized or un-polarized. The diffuser 126 may be configured to reduce the angular color spread in the light output (primary and secondary light) from top surface 114 of the plate 104 compared to use of a plate 104 without the diffuser 126. In one embodiment, the index of refraction of the diffuser 126 is different from the index of refraction of the plate 104.

The diffuser 126 may be positioned a distance from the plate 104. For example, as shown in FIG. 1, a bottom surface 130 of the diffuser 126 may be positioned a distance L₁ from the top surface 114 of the plate 104. The distance L₁ may vary. In one embodiment, the distance L₁ may range from 0.1 mm to 40 mm. In another embodiment, for example, the distance L₁ may range from 1.0 mm to 20 mm. The diffuser 126 may be configured to control the illumination pattern of the mixed light. Depending on the desired output or illumination patterns, such as intensity and/or various view angles, the diffuser 126 may include a material having a size, shape and/or refractive index chosen to allow reduced color angular spread of the light emitted from the top surface 114 of the plate 104 compared to the color angular spread in the absence of the diffuser 126. For example, the diffuser 126 may include a ground glass diffuser, holographic diffuser, or microlens diffuser. In addition, a polygonal/circular TIR or minor reflector may be used to perform color mixing.

As shown, the plate 104 may be formed separately from the LED 102 and may be coupled in a known manner to the LED 102 so that light from the light emitting surface 116 of the LED 102 passes through the bottom surface 112 of the plate 104. The plate 104 may be positioned a distance from the LED 102, wherein the plate 104 may be supported within the assembly 100 by any known means, including support from a portion of a housing (not shown) of the assembly 100. As shown in FIG. 1, the bottom surface 112 of the plate 104 may be positioned remotely from the emitting surface 116 of the LED 102 by a distance L₂. The distance L₂ may be set according to desired operating conditions and performance. In one embodiment, the distance L₂ may range from 0.1 mm to 3 mm. In another embodiment, for example, the distance L₂ may range from 0.5 mm to 1 mm. Positioning the plate 104 a distance from the LED 102 generally allows the plate 104 to be formed into a shape that may be different from the surface of the LED 102. For example, the plate 104 may include a plate, dome, or shell shape and/or dimension, wherein the surface of the plate 104 can be circular, ellipse, or free form. Preferably, plate 104 is a flat plate as shown in FIG. 1.

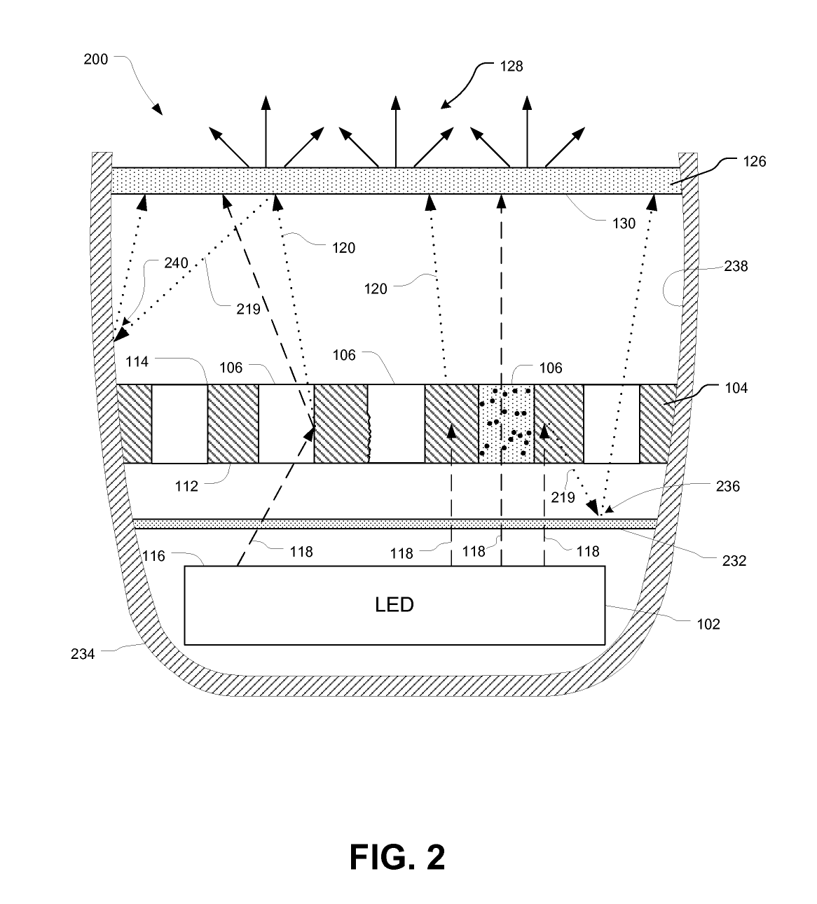

Turning now to FIG. 2, another embodiment of a wavelength-converted LED assembly 200 including structures (232, 234) configured to re-direct back scattering of light is illustrated in cross section. In the illustrated embodiment, the wavelength-converted LED assembly 200 includes the LED 102, wavelength-converting plate 104, and diffuser 126 of the assembly 100 of FIG. 1. Back scattering of light may be generally understood to mean light scattered back towards a direction from which the light was emitted. As shown, back scattered light, e.g. indicated by arrows 219, may include light directed away from the plate 104 and/or diffuser 126 in a direction towards the LED 102. As shown, the backscattered light 219 includes secondary light 120 in a direction towards the LED 102.

In one embodiment, the assembly 200 may include an optical filter 232 configured to selectively allow primary light 118 to pass through at least a portion of the filter 232 and to prevent secondary light 120, including backscattered secondary light 219, from passing through the filter 232 in at least a direction towards the LED 102. In particular, the filter 232 may be further configured to reflect backscattered secondary light 219 in a direction away from the LED 102, as indicated by arrow 236. As shown, the filter 232 is positioned between the emitting surface 116 of the LED 102 and the bottom surface 112 of the plate 104. In another embodiment, the filter 232 may be directly coupled to the emitting surface 116 of the LED 102. In another embodiment, the filter 232 may be positioned between the top surface 114 of the plate 104 and bottom surface 130 of the diffuser 126. The optical filter 232 may include, for example, a dichroic filter, thin-film filter, and/or interference filter.

In another embodiment, the assembly 200 may include a reflector 234. The reflector 234 may be configured to reflect light such that a desired illumination pattern, such as a down light, flood light, etc., may be emitted from the assembly 200. The reflector 234 may be configured to re-direct backscattered light 219 in a direction away from the LED 102. As shown, the LED 102, plate 104 and diffuser 126 may be enclosed within the reflector 234. The reflector 234 may include an internal surface 238 configured to reflect backscattered light 219 in a direction away from the LED 102, as indicated by arrow 240.

The plurality of apertures 106 may be formed in the plate 104 in a desired pattern and/or distribution, and the size (including depth and diameter) and shape of the apertures 106 may vary depending on the application and intended outcome. For example, different color temperature and/or color uniformity can be achieved by varying the aperture 106 geometry and/or distribution. Additionally, the fraction of converted light from the plate 104 can be controlled by varying the volume of each of the plurality of apertures 106, thereby improving color uniformity over angle and allowing optimization of efficacy and color.

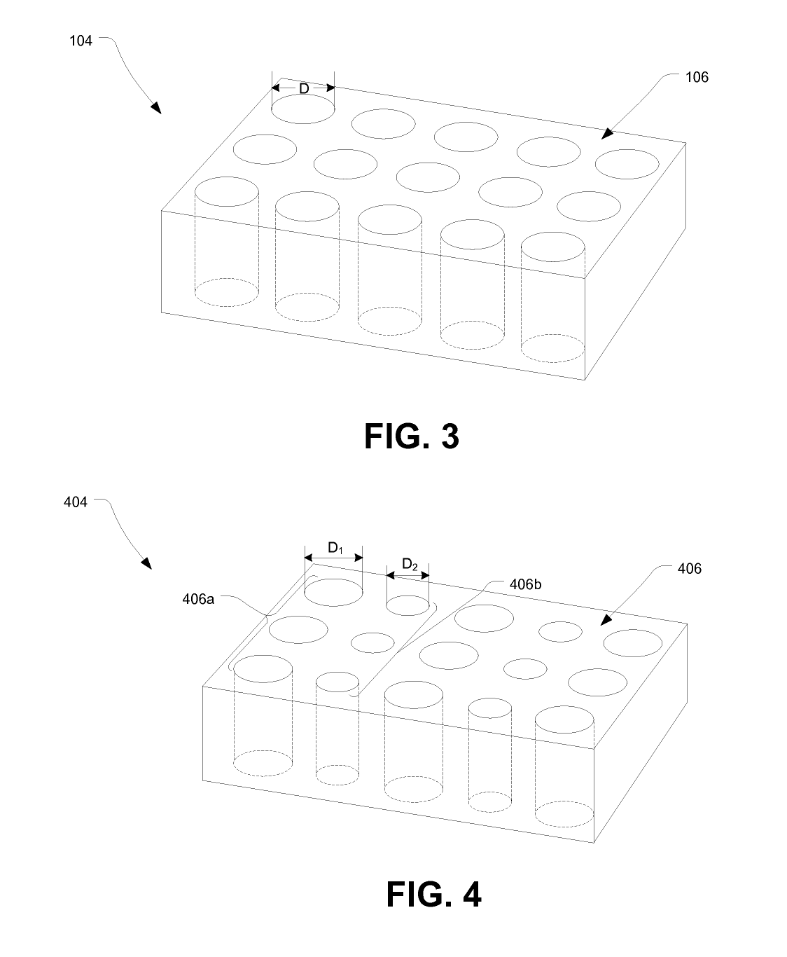

A plate 104 consistent with the present disclosure may include a plurality of apertures 106 having uniform and/or varying size in a uniform and/or varying distribution. FIG. 3 diagrammatically illustrates the wavelength-converting plate 104 shown in FIG. 1 in perspective view. It should be noted that several exemplary internal features and/or surfaces are illustrated as hidden lines in FIG. 3. As shown in FIG. 3, for example, the plate 104 includes a plurality of apertures 106 formed therein, wherein each of the apertures 106 are generally uniform in size and distribution. As shown, each aperture 106 is substantially round in shape and may have a diameter D and may be spaced equidistantly from one another. In one embodiment, the diameter D of an aperture 106 may range from 0.1 mm to 2 mm. In another embodiment, for example, the diameter D of an aperture 106 may range from 0.5 mm to 1 mm.

FIG. 4 diagrammatically illustrates another embodiment of a wavelength-converting plate consistent with the present disclosure in perspective view. It should be noted that several exemplary internal features and/or surfaces are illustrated as hidden lines in FIG. 4. As shown, a wavelength-converting plate 404 may include a plurality of apertures 406 formed therein, wherein a first set 406a of the plurality of apertures 406 may have a first diameter D₁ and a second set 406b of the plurality of apertures 406 may have a second diameter D₂ different from the first diameter D₁. Although the apertures 106, 406 in FIGS. 3 and 4 are shown having a substantially round shape, it should be noted that the apertures may have a variety of shapes, including, but not limited to, substantially round, elliptical, rectangular, square, etc. For example, in one embodiment, the apertures may have a substantially rectangular shape and may extend a portion of the length and/or width of the plate.

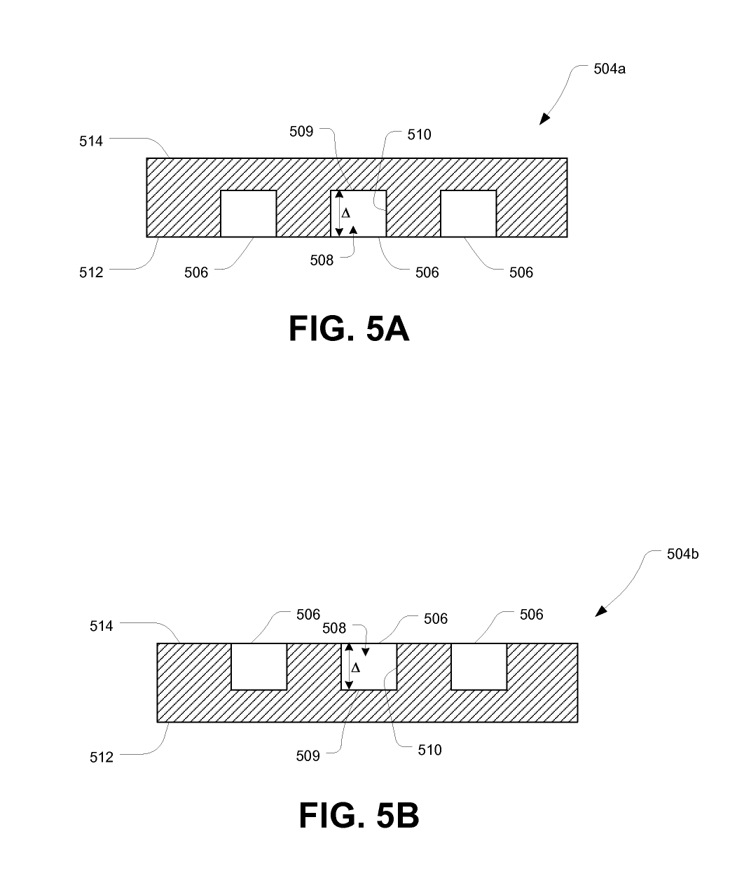

FIGS. 5A-5B diagrammatically illustrate in cross section other embodiments of a wavelength-converting plate consistent with the present disclosure. As shown in FIG. 5A, a wavelength-converting plate 504a may include a plurality of apertures 506 defined in a portion thereof. In the illustrated embodiment, at least one of the plurality of apertures 506 may form a blind hole 508 having a sidewall 510, the blind hole 508 extending from a bottom surface 512 of the plate 504a to an interior 509 of the plate 504a. As shown, the blind hole 508 of at least one aperture 506 partially extends through the plate 504a from the bottom surface 512 without fully extending through the entirety of the plate (i.e. from the bottom surface 512 to the top surface 514). Alternatively, as shown in FIG. 5B, a wavelength-converting plate 504b may include a plurality of apertures 506 defined in a portion thereof, wherein at least one of the apertures 506 forms a blind hole 508 extending from a top surface 514 of the plate 504b to an interior 509 of the plate 504b. As shown, the passage 510 of at least one aperture 506 partially extends through the plate 504a from the top surface 514 without fully extending through the entirety of the plate (i.e. from the top surface 514 to the bottom surface 512). With respect to both plates 504a and 504b, the blind hole 508 of each of the apertures 506 may have a depth Δ, measured from the bottom surface 512 (in the case of plate 504a) or the top surface 514 (in the case of plate 504b) to the interior 509, wherein the depth Δ is at least one percent of the thickness of the plate 504a, 504b, and preferably at least 10 percent of the thickness of the plate, and more preferably at least 25 percent of the thickness of the plate.

Similar to plate 104 described earlier, primary light emitted from an LED may be imparted onto the bottom surface 512 of the plate 504a, 504b. Some of the primary light may pass into and through the bottom surface 512 of the plate 504a, 504b, wherein some of the primary light may interact with and excite the wavelength-converting material within the plate 504a, 504b, wherein the plate 504a, 504b may emit secondary light. Additionally, some of the primary light passing into the bottom surface 512 of the plate 504a, 504b may pass through the plate 504a, 504b from the bottom surface 512 to the top surface 514 without interacting with the wavelength-converting material and thus remain unconverted.

At least one of the plurality of apertures 506 may be configured to allow some of the primary light imparted upon the plate 504a, 504b to pass at least partially through the plate 504a, 504b without being imparted on a surface thereof. In particular, referring to FIG. 5A, for example, some primary light may pass from the LED directly into a blind hole 508 of at least one aperture 506 defined on the bottom surface 512 of the plate 504A, thereby passing at least partially through the plate 504a without being imparted one surface thereof. Similarly, in reference to FIG. 5B, some primary light may remain unconverted while passing from the bottom surface 512 to an interior 509 of the plate 504b, wherein the primary light may pass from the interior 509 into a blind hole 508 of at least one aperture 506 defined on the top surface 514 of the plate 504b.

The plurality of apertures 506 may have similar effects as the plurality of apertures 506 described earlier. In particular, the plurality of apertures 506 may be configured to increase interaction area between primary light emitted by an LED and the wavelength-converting material of the plate 504a, 504b, thereby increasing conversion efficiency. The plurality of apertures 506 may also be configured to provide convective pathways for dissipating thermal energy generated by the LED and/or plate 504a, 504b.

A light source including one embodiment of a wavelength-converting plate consistent with the present disclosure was simulated for color performance. Simulations were performed using LightTools® optical engineering and design software offered by Synopsys Inc. (Mountain View, Calif.). The light source included an LED array having an overall 30 mm by 30 mm Lambertian emitting surface, wherein the primary light emitted by the LED had a peak wavelength of 460 nm. The wavelength-converting plate, including a YAG:Ce phosphor, was positioned approximately 0.5 mm above the emitting surface of the LED. Additionally, a diffuser was positioned approximately 35 mm away from the top surface of the wavelength-converting plate. Simulations were performed using wavelength-converting plates having different sized apertures defined therein. For example, simulation was performed on a plate including apertures having a diameter of approximately 0.5 millimeters (mm). Similarly, simulation was performed on additional plates including apertures having a diameter of approximately 1.0 mm and 1.5 mm, respectively. In particular, Table 1 below shows the color performance results generated by the simulations.

TABLE 1
Color CIE

| | | Near Field | | | |
|---|---|---|---|---|---|
| Aperture | | Irradiance | | Far Field Intensity | |
| Size | CIE color | | Standard | | Standard |
| (diameter) | coordinate | Mean | Deviation | Mean | Deviation |
| 0.5 mm | Cx | 0.4362 | 0.014 | 0.4062 | 0.026 |
| | Cy | 0.5434 | 0.0121 | 0.4922 | 0.0452 |
| 1.0 mm | Cx | 0.4363 | 0.0148 | 0.408 | 0.0296 |
| | Cy | 0.5414 | 0.0139 | 0.4848 | 0.0421 |
| 1.5 mm | Cx | 0.4288 | 0.0221 | 0.4079 | 0.0375 |
| | Cy | 0.5362 | 0.022 | 0.4708 | 0.0483 |

As shown, the tests results correlate to the diameter of the apertures. The near field irradiance and far field intensity were both measured. The irradiance (near field) is the optical power per unit area, as a function of the detector coordinates x and y. The intensity (far field) is the optical power per solid angle (e.g. view angle), a function of latitude and longitude (the light surface normal taken as north pole). The CIE color coordinates (Cx, Cy) are calculated based on both near field and far field distributions. The smaller the value (closer to zero) of the standard deviation, the more uniform the color.

As shown, the color performance (CIE color measurements) of the plate having 1.5 mm apertures has a larger deviation when compared to plates having 0.5 mm and 1.0 mm apertures. In particular, the Cx standard deviation values for the near and far field measurements for the 1.5 mm aperture plate were 0.0221 and 0.0375, respectively. The Cx standard deviation values for the near and far field measurements for the 0.5 mm and 1.0 mm aperture plates were 0.0014, 0.026 and 0.0148, 0.0296, respectively. Because the standard deviation values for the 0.5 mm and 1.0 mm aperture plates were smaller than the 1.5 mm aperture plate, the 0.5 mm and 1.0 mm aperture plates exhibit greater color uniformity than the 1.5 mm aperture plate.

Although the 0.5 mm aperture plate exhibits the smallest standard deviation values, and thus exhibits greatest color uniformity, the 1.0 mm aperture plate may be the optimal aperture size. In particular, the color performance between the 0.5 mm and 1.0 mm aperture plates is minimal. Due to the fact that the 1.0 mm aperture plate has less phosphor material per unit area, which in turn generates less heat from Stokes shift, the 1.0 mm aperture plate may be the optimal aperture size.

According to one aspect of the present disclosure, there is provided a light module. The light module includes a solid-state light source configured to emit primary light from an emitting surface and a wavelength-converting plate. The wavelength-converting plate is comprised of a wavelength-converting material for converting at least a portion of the primary light into a secondary light. The wavelength-converting plate has a bottom surface in opposed facing relationship to the emitting surface of the light source and a top surface for emitting the secondary light. The wavelength-converting plate further includes a plurality of apertures formed therein. Preferably, at least one of the plurality of apertures is configured to allow the primary light to pass at least partially through said wavelength-converting plate without being imparted on a surface thereof.

According to another aspect of the present disclosure, there is provided a wavelength-converting plate for a light module including a solid-state light source configured to emit primary light. The wavelength-converting plate includes a top surface and a bottom surface, wherein the bottom surface is positioned in an opposed facing relationship to an emitting surface of the light source. The wavelength-converting plate includes a plurality of apertures formed therein and is comprised of a wavelength-converting material for converting at least a portion of the primary light into a secondary light. Preferably, at least one of the plurality of apertures is configured to allow the primary light to pass at least partially through said wavelength-converting plate without being imparted on a surface thereof.

While the principles of the present disclosure have been described herein, it is to be understood by those skilled in the art that this description is made only by way of example and not as a limitation as to the scope of the invention. The features and aspects described with reference to particular embodiments disclosed herein are susceptible to combination and/or application with various other embodiments described herein. Such combinations and/or applications of such described features and aspects to such other embodiments are contemplated herein. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A light module comprising:
a solid-state light source configured to emit primary light from an emitting surface; and
a wavelength-converting plate comprising a wavelength-converting material for converting at least a portion of said primary light into a secondary light, said wavelength-converting plate having a bottom surface in opposed facing relationship to said emitting surface of said light source and a top surface for emitting said secondary light, said wavelength-converting plate further having a plurality of apertures formed therein.

2. The light module of claim 1 wherein said plurality of apertures comprise through holes extending between said top and bottom surfaces.

3. The light module of claim 2 wherein at least one through hole has a diameter different from at least one other through hole.

4. The light module of claim 1 wherein said plurality of apertures comprise blind holes in said wavelength-converting plate.

5. The light module of claim 4 wherein said blind holes are formed in said bottom surface of said wavelength-converting plate.

6. The light module of claim 4 wherein said blind holes are formed in said top surface of said wavelength-converting plate.

7. The light module of claim 1 wherein said wavelength-converting plate is positioned remotely from said light source.

8. The light source of claim 7 wherein a distance between said bottom surface of said wavelength-converting plate and said emitting surface of said light source is between about 0.1 mm and 3 mm.

9. The light source of claim 1 wherein at least one of said plurality of said apertures has a diameter between about 0.1 mm to 2 mm.

10. The light source of claim 1 wherein at least one of said plurality of said apertures has a diameter between about 0.5 mm to 1 mm.

11. The light module of claim 1 wherein at least one of said apertures contains an optically transparent material.

12. The light module of claim 11 wherein said optically transparent material contains light scattering particles.

13. The light module of claim 11 wherein said plurality of apertures comprise through holes extending between said top and bottom surfaces.

14. The light module of claim 12 wherein said plurality of apertures comprise through holes extending between said top and bottom surfaces.

15. The light module of claim 1 wherein at least one of said plurality of apertures is configured to allow said primary light to pass at least partially through said wavelength-converting plate without being imparted on a surface thereof.

16. The light module of claim 1 wherein at least a portion of a side wall of at least one of said plurality of apertures is textured.

17. A wavelength-converting plate for a light module including a solid-state light source configured to emit primary light, said wavelength-converting plate comprising:
a wavelength-converting material for converting at least a portion of said primary light into a secondary light, said wavelength-converting plate having a bottom surface in opposed facing relationship to said emitting surface of said light source and a top surface for emitting said secondary light, said wavelength-converting plate further having a plurality of apertures formed therein.

18. The wavelength-converting plate of claim 17 wherein said plurality of apertures are configured to increase interaction area between said primary light and said wavelength-converting material.

19. The wavelength-converting plate of claim 17 wherein each of said plurality of apertures are spaced equidistantly apart from one another.

20. The wavelength-converting plate of claim 17 wherein said plurality of apertures comprise through holes extending between said top and bottom surfaces.

21. The wavelength-converting plate of claim 20 wherein at least one through hole has a diameter different from at least one other through hole.

22. The wavelength-converting plate of claim 17 wherein said plurality of apertures comprise blind holes in said wavelength-converting plate.

23. The wavelength-converting plate of claim 22 wherein said blind holes are formed in said bottom surface of said wavelength-converting plate.

24. The light module of claim 22 wherein said blind holes are formed in said top surface of said wavelength-converting plate.

25. The light module of claim 17 wherein at least one of said plurality of apertures is configured to allow said primary light to pass at least partially through said wavelength-converting plate without being imparted on a surface thereof.
